(19) United States
(12) Patent Application Publication
(10) Pub. No.: US 2004/0115604 A1
(43) Pub. Date: Jun. 17, 2004

(54) Didactic stuffed rabbits with printed messages

(76) Inventor: Peggy K. Dear, New Boston, TX (US)

Correspondence Address: Richard C. Litman, LITMAN LAW OFFICES, LTD., P.O. Box 15035, Arlington, VA, 22215, US

(21) Appl. No.: 10/695,157

(22) Filed: Oct. 29, 2003

Related U.S. Application Data
(60) Provisional application No. 60/423,592, filed on Nov. 5, 2002.

(51) Int. Cl. G09B 19/00

(52) U.S. Cl. 434/236

(57) ABSTRACT

An assortment of stuffed rabbit toys for educating children in certain activities, and to encourage them to learn and form a beneficial habit.

### CROSS-REFERENCE TO RELATED APPLICATION

This application claims the benefit of U.S. Provisional Patent Application Serial No. 60/423,592, filed Nov. 5, 2002.

### BACKGROUND OF THE INVENTION

1. Field of the Invention

The present invention relates generally to toys. More specifically, the invention is an assortment of stuffed rabbits representing various sports and topics to educate children in certain activities and to encourage them to learn and form a beneficial habit.

2. Description of Related Art

The related art of interest describes various educational toys, but none discloses the present invention. There is a need in this educational age with rapidly evolving technology that children must be educated to read and understand what they read at an earlier age than ever. The stuffed rabbits are used to encourage children to participate in certain activities such as sports, brushing one's teeth, dancing, exercising, reading, and the like activities. The related art will be discussed in the order of perceived relevance to the present invention.

U.S. Pat. No. 5,944,533 issued on Aug. 31, 1999, to Michael C. Wood describes an interactive educational toy in the form of a plush figure such as a frog, household pets, cartoon figures, human figures, hybrid fantasy designs, and a telephone. The toy teaches and reinforces a child's knowledge of letter names, letter phonetics, colors, numbers, and social manners by means of visual, audible and kinesthetic involvement of the child. The toy has a plurality of indicia, a switching circuitry electrically connected to the indicia, a logic circuit, and a sound synthesizer and speaker. The toy is distinguishable for requiring an electrical logic circuitry and speaker.

U.S. Pat. No. 5,842,870 issued on Dec. 1, 1998, to Carol P. Cramer describes a stuffed bear having a plurality of medical injection sites for a diabetic child to teach the child the medication sites. The toy is distinguishable for being limited to instructing children the diabetes medication sites on one's body.

U.S. Pat. No. 5,478,240 issued on Dec. 26, 1995, to Mary Ann Cogliano describes an electronic toy for teaching a child language and arithmetic skills utilizing a keyboard. A turtle is illustrated which opens its shell to reveal a keyboard. Proper depression of the keys would be vocalized by the toy and displayed on a display. Various portions of the turtle would move base upon the proper depression of the keys. The toy is distinguishable for requiring electronic features and a keyboard.

U.S. Pat. No. 4,197,670 issued on Apr. 15, 1980, to Zula B. Cox describes a stuffed fabric doll with a trunk cavity with a fabric door to contain a baby doll. The mother doll has self-adherent patches on selected positions on it for attaching the baby doll. The doll is distinguishable for being limited to a mother and baby doll set.

U.S. Pat. No. 4,822,285 issued on Apr. 18, 1989, to Stephan W. Summerville describes an anatomically stuffed toy animal such as a kitten, dog, squirrel, etc. having a cavity filled with various anatomical parts or printed parts such as lungs, kidney, liver, stomach, and heart. An educational tape recorder can be added inside the head. The toy is distinguishable for requiring anatomical parts and a tape recorder.

U.S. Pat. No. 4,973,052 issued on Nov. 27, 1990, to Donald J. Conti describes am electronic educational toy in the form of a policeman on a base containing an electronic sensor assembly and a control unit. Visual indicators on the body and an audio output are also provided. The toy is distinguishable for requiring electronic and audio elements.

U.S. Pat. No. 5,645,432 issued on Jul. 8, 1997, to Richard V. Jessop describes an educational toy device in the form of a book with pages having pressure sensors and the covers having cooperative pressure sensors and a sound generator. The toy is distinguishable for requiring electronic and audible components.

U.S. Pat. No. 5,949,010 issued on Sep. 7, 1999, to L. Leonard Hacker describes musical blocks for teaching music to children 5 to 10 years of age. The sides of the blocks can display musical indicia on certain sides. Sound initiators such as reeds are included. The devices are distinguishable for requiring blocks to teach musical features.

U.S. Pat. No. 6,010,339 issued on Jan. 4, 2000, to David L. McDonald describes a toy telephone having a phone number teaching system comprising a telephone style housing having a keypad with a four by three matrix of depressible buttons, each bearing a number or symbol. The housing supports a pageable book having a plurality of pivotally secured pages, each bearing a selected image and a corresponding number. A simulated telephone hand unit is secured to the housing by a safety cord and receivable within a cradle. Each depressible button includes a lighting device and a pushbutton switch. An electronic circuit in the housing operates the plurality of switches and lights associated with the plurality of buttons in accordance with a store instruction set. The device is distinguishable for requiring electronic features.

U.S. Pat. No. 6,142,784 issued on Nov. 7, 2000, to Michael C. Wood describes a mathematical electronic learning game device that provides a plurality of pedagogical and instructional modalities that combine strong kinesthetic, auditory, and visual stimulation to assist a child to learn basic arithmetical concepts. The game utilizes a combination of voice statements, rhythmic music, a visual display, and manual inputs from number dials and a response switch to achieve multi-modal learning of arithmetic concepts. The device is distinguishable for requiring a visual display, electronic components and an audio feature.

U.S. Design Patent No. 289,073 issued on Mar. 31, 1987, to Jody Fineman describes a stuffed sitting toy rabbit without any indicia and the like attributes.

U.S. Design Patent No. 323,365 issued on Jan. 21, 1992, to Laaurie D. Wyeth describes a standing stuffed rabbit dressed in a suit with heart indicia in its eyes, nose, palms, and the bottoms of its feet without any didactic indicia.

None of the above inventions and patents, taken either singly or in combination, is seen to describe the instant invention as claimed.

### SUMMARY OF THE INVENTION

Stuffed rabbits are used to encourage children to participate in certain activities such as sports, brushing one's teeth, dancing, exercising, reading, and the like activities. The didactic toys have instructive original poems inscribed either on their chests or on the exposed bottoms of their feet. Long poems can be attached as a tag on the toy's neck, wrist, paw or ear. The instructive and suggestive toys are used to encourage children to take part in certain children and adult activities. These toys can be collected as a hobby because each toy is unique.

Accordingly, it is a principal object of the invention to provide a didactic stuffed toy.

It is another object of the invention to provide a didactic stuffed toy in the form of a sitting rabbit.

It is a further object of the invention to provide a didactic stuffed rabbit representing a sports activity or other children and adult activities.

Still another object of the invention is to provide a series of didactic stuffed rabbits having a poem inscribed on either their chests, the bottoms of their feet, or printed in a pamphlet attached to either the paw, wrist, ear or neck.

It is an object of the invention to provide improved elements and arrangements thereof in a series of didactic stuffed rabbits for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a front elevational view of a stuffed rabbit holding a bat, wearing a baseball hat to illustrate a baseball player, and the word “BASEBALL” printed on the soles of its large feet, and/or in a pamphlet hung from its folded down ear to illustrate the sport of baseball according to a first embodiment of the present invention.

FIG. 2 is a front elevational view of a stuffed rabbit holding a football, wearing a football helmet to depict a football player, and having the word “FOOTBALL” on the soles of its large feet, or in a pamphlet hung from a wrist or the folded down ear to illustrate the sport of football according to a second embodiment of the present invention.

FIG. 3 is a front elevational view of a stuffed rabbit holding a baton, wearing a majorette cap to illustrate a majorette theme, and having a printed word “MAJORETTE” on the soles of its large feet, and/or in a pamphlet on its wrist or its folded down ear according to a third embodiment of the present invention.

FIG. 4 is a front elevational view of a stuffed rabbit holding a tennis racquet, wearing a tennis cap to illustrate the sport of tennis, and having either a printed word “TENNIS” on the soles of its large feet, or in a pamphlet on its wrist or folded ear according to a fourth embodiment of the present invention.

FIG. 5 is a front elevational view of a stuffed rabbit reading a book according to a fifth embodiment of the present invention.

FIG. 6 is a front elevational view of a stuffed rabbit praying according to a sixth embodiment of the present invention.

FIG. 7 is a front elevational view of a stuffed rabbit teaching according to a seventh embodiment of the present invention.

Similar reference characters denote corresponding features consistently throughout the attached drawings.

### DETAILED DESCRIPTION OF THE PREFERRED EMBODIMENTS

The present invention is directed to educational toys for children emphasizing a particular sport or event. It should be understood that although stuffed rabbits are illustrated, the toy can be various other animals such as pigs, dogs, cats, alligators, birds, and insects such as butterflies, bees, and the like. The materials for filling the stuffed toy are conventional.

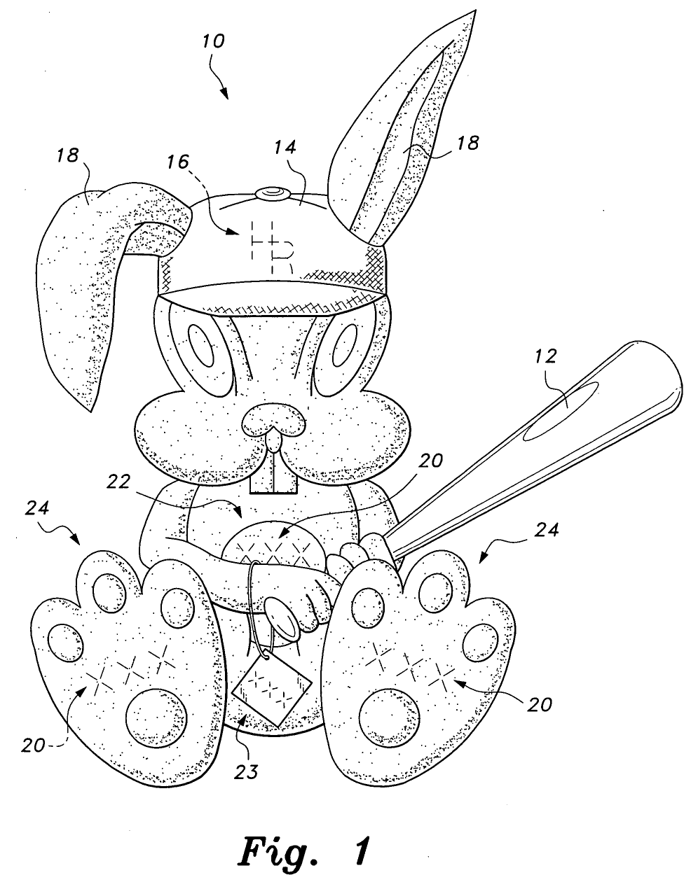

In the first embodiment illustrated in FIG. 1, a baseball player stuffed rabbit 10 has a bat 12 in its grasp. A baseball style cap 14 with an “HR” monogram 16 in front is on its head with its long ears 18 penetrating. An indicia 20 appears on its chest 22, and/or on the soles 24 of its large feet, and/or in a pamphlet 23 hung from its folded down ear 18. The poem can be distributed between the three locations as: “I've got the baseball habit, I love to hit and run. Try playing baseball if you want to have some fun.”. An older sibling or parent can recite these words and point to the relevant words. The child can now associate the sport of baseball with words in the form of a poem. There are no electronic features necessary. No audible circuitry need be employed inside the rabbit. Yet the child has the educational benefit supplied by another older person. When baseball games are televised, the child can associate what was learned from the toy to reinforce his/her knowledge of this activity.

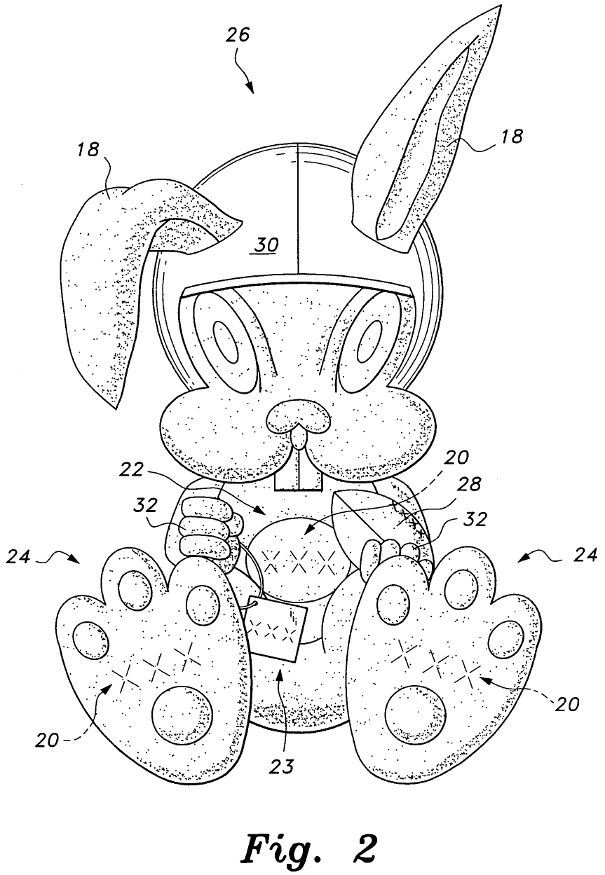

A second embodiment focussing on football is depicted in FIG. 2. The football playing rabbit 26 is carrying a football 28 and wearing a football helmet 30. The indicia (poem) 20 can be written on the chest 22 and on the soles 24. Alternatively, the poem can be placed either inside each large ear 18, on the paws 32 (hidden), on arm bands (not shown), or in a pamphlet 23 hung from a wrist. The football poem is: “I've got the football habit. I practice very hard. I'm a quarterback on offense. On defense, I'm a guard.”. Again, football is shown on television and in newspapers during its playing season. The child has been informed of the sport and some of its required uniform.

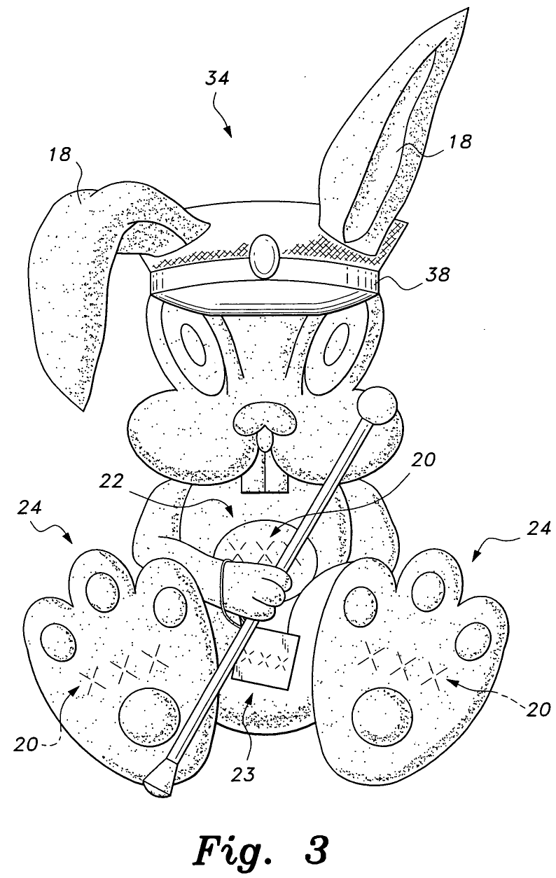

A third embodiment shown in FIG. 3 is a rabbit 34 portraying a drum major or majorette that would be appealing to either a male or female child. A baton 36 is held in one paw 32. A drum major or majorette cap 38 is on its head. The indicia 20 can be a poem such as: “I've got the twirling habit. My! How I love the band. Watch me twirl this baton I have in my hand.”. The child can readily associate with this rabbit 34 when he/she sees parades with leading drum majors or majorettes.

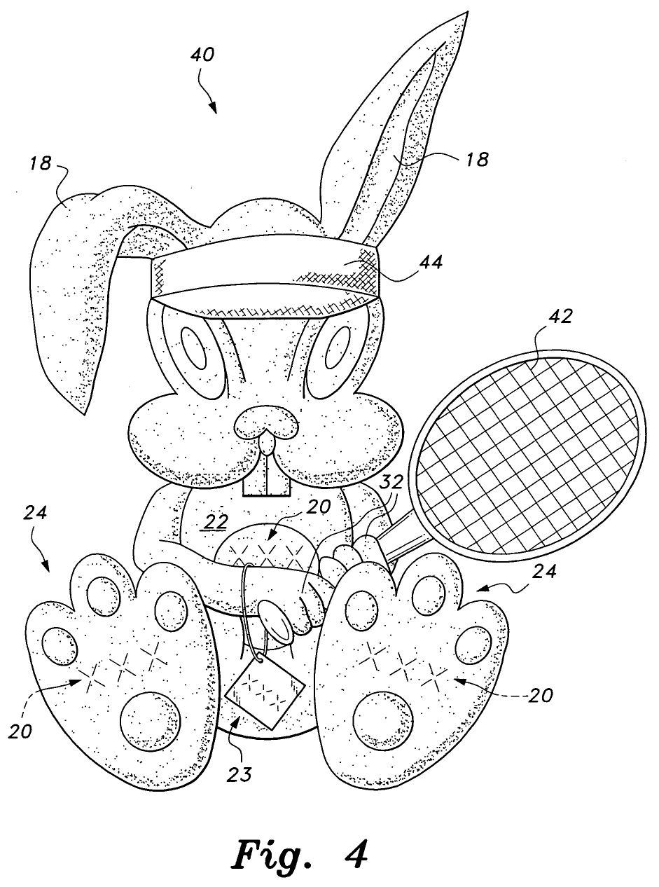

A fourth embodiment depicted in FIG. 4 is a rabbit 40 equipped with a tennis racquet 42 and wearing a tennis cap 44. The indicia 20 can be a poem such as: “Tennis is my habit. I usually play the net. Watch me close and you will see game, match set.”.

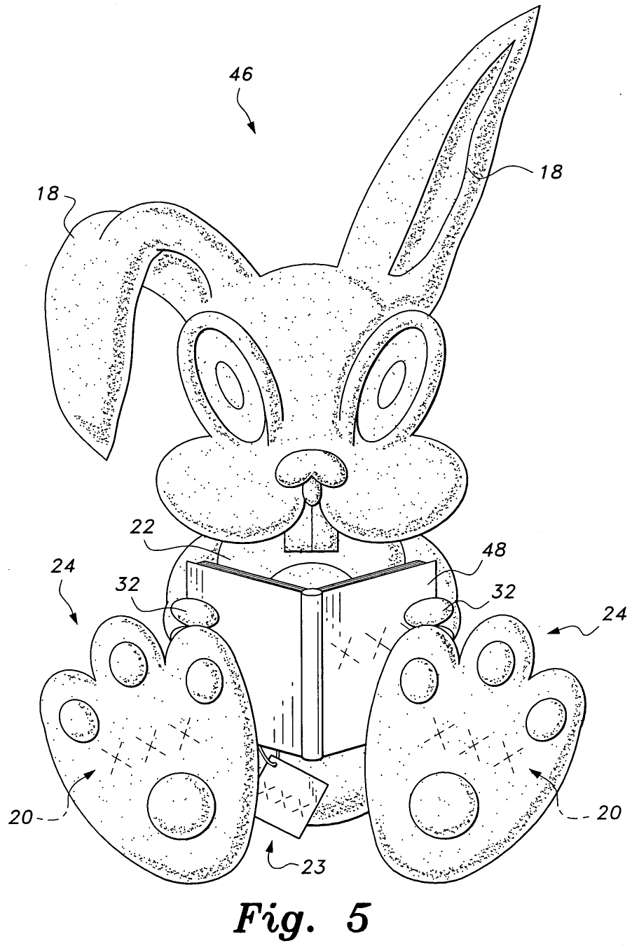

A fifth embodiment shown in FIG. 5 is a rabbit 46 reading a book 48 to suggest and encourage the reading habit to a child.

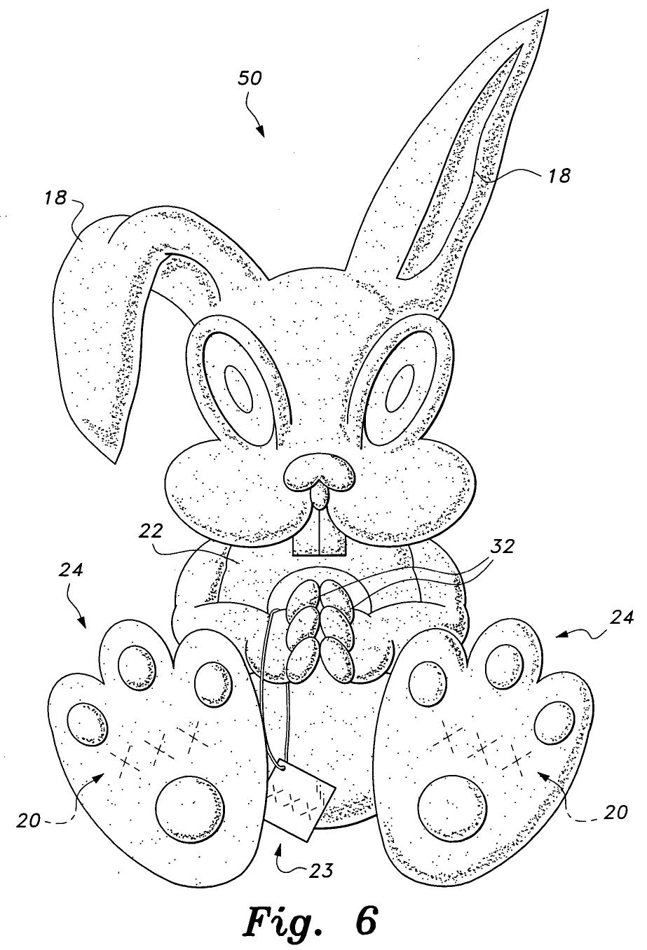

A sixth embodiment illustrated in FIG. 6 is a praying rabbit 50 praying with its front paws 32 held together.

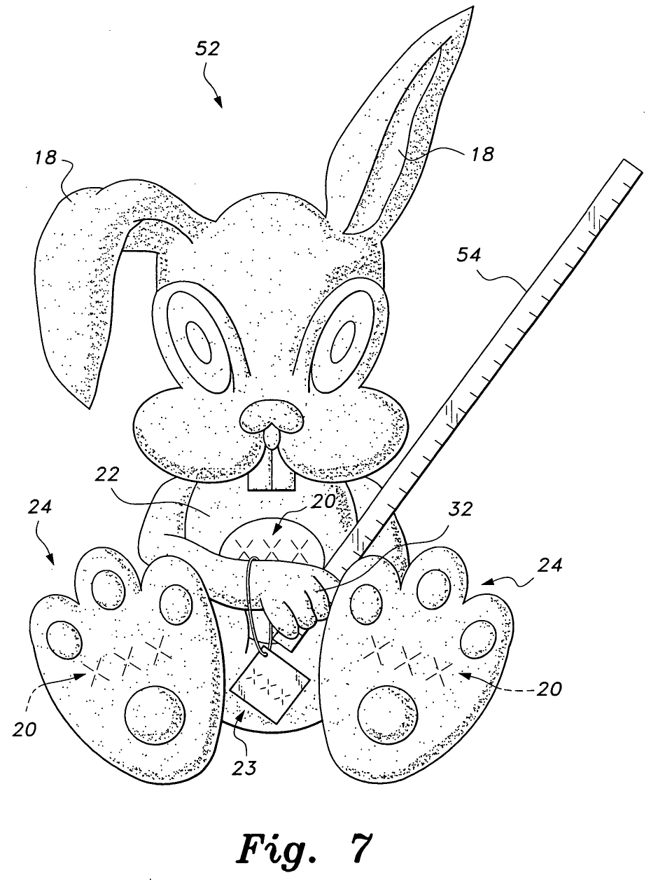

A seventh embodiment depicted in FIG. 7 is a teaching rabbit 52 holding a pointer stick 54 to aid in pointing to certain topics on a blackboard.

Thus, various stuffed rabbits illustrating various popular sports emphasize not only the equipment used, but the terminology employed in that sport or activity. Clearly, other sports themes such as basketball, track, handball, volleyball, swimming, horseback riding, soccer, ice skating, and roller (blade) skating, can be implemented. Also, stuffed rabbits encouraging reading, praying and paying attention to teachers are included.

It is to be understood that the present invention is not limited to the sole embodiments described above, but encompasses any and all embodiments within the scope of the following claims.

I claim:

1. A didactic stuffed rabbit bearing a message for a child comprising:
a stuffed rabbit in a sitting position having two long ears, large eyes and large feet positioned in front exposing soles;
a sports activity theme exhibited by sports equipment and headgear selected from the group consisting of baseball, football, tennis, and majorette; and
indicia on either a chest and/or soles of the stuffed rabbit, or in a pamphlet attached to a wrist, paw or neck;
whereby a child can understand and relate to various sports or life activities as well as the indicia.

2. The didactic stuffed rabbit according to claim 1, wherein the indicia is a poem based on the specific sports activity portrayed by the rabbit and its equipment.

3. The didactic stuffed rabbit according to claim 1, wherein the sports activity theme is baseball.

4. The didactic stuffed rabbit according to claim 1, wherein the sports activity theme is football.

5. The didactic stuffed rabbit according to claim 1, wherein the sports activity theme is tennis.

6. The didactic stuffed rabbit according to claim 1, wherein the sports activity theme is a majorette.

7. The didactic stuffed rabbit according to claim 1, wherein the indicia is on the chest of the stuffed rabbit.

8. The didactic stuffed rabbit according to claim 1, wherein the indicia is on the chest and soles of the stuffed rabbit.

9. The didactic stuffed rabbit according to claim 1, wherein he indicia is on the soles of the stuffed rabbit.

10. The didactic stuffed rabbit according to claim 1, wherein the pamphlet is attached to a wrist of the stuffed rabbit.

11. The didactic stuffed rabbit according to claim 1, wherein the pamphlet is attached to a paw of the stuffed rabbit.

12. The didactic stuffed rabbit according to claim 1, wherein the pamphlet is attached to the neck of the stuffed rabbit.

13. The didactic stuffed rabbit according to claim 1, wherein the pamphlet is attached to the ear of the stuffed rabbit.

14. The didactic stuffed rabbit according to claim 1, wherein the activity is reading.

15. The didactic stuffed rabbit according to claim 1, wherein the activity is praying.

16. The didactic stuffed rabbit according to claim 1, wherein the activity is teaching.
